(19) United States
(12) Patent Application Publication
(10) Pub. No.: US 2009/0235806 A1
(43) Pub. Date: Sep. 24, 2009

(54) STRUCTURE OF DRUM PEDAL

(76) Inventor: MING-HWAI CHEN, Taichung Hsien (TW)

Correspondence Address: LEONG C LEI, PMB # 1008, 1867 YGNACIO VALLEY ROAD, WALNUT CREEK, CA, 94598, US

(21) Appl. No.: 12/053,629

(22) Filed: Mar. 24, 2008

(51) Int. Cl. G10D 13/02

(52) U.S. Cl. 84/422.1

(57) ABSTRACT

A structure of a drum pedal is provided for automatically returning of the pedal. The pedal drives a mallet that is mounted to a shaft and is rotated by the depression of the pedal to hit a drum. A rotary member is mounted to the shaft and carries a first magnet. An erect support is arranged to oppose the rotary member and carries a second magnet opposing the first magnet. When the pedal is depressed to drive the mallet to hit the drum, a magnetic interaction induced between the first and second magnets to automatically return the pedal to the original location before depression in a soundless manner.

### BACKGROUND OF THE INVENTION

(a) Technical Field of the Invention

The present invention relates to an improved structure of a drum pedal, which comprises a shaft for rotating a mallet and carrying a rotary member at a desired inclination so that when the shaft is rotated, the rotary member is brought to a location facing an erected plate support, and with magnets mounted to opposing surfaces of the plate support and the rotary member and having a desired arrangement of the magnetic poles thereof, after the pedal is depressed, an expelling force is induced to provide assistance for realizing automatic and efficient returning of the pedal.

(b) Description of the Prior Art

For the percussion of a conventional base drum, in the arrangement of a complete set of instruments, the percussion of the drum head is often realized by a pedal that is in operative coupling with a mallet that is arranged in a lower front location with respect to the base drum. As shown in FIG. 5 of the attached drawings, the pedal has a pedal body 30 that is pivoted to a base 31 at a central location above the base 31. Two erected posts 32 are arranged at one end of the base 31 for supporting a shaft 33. The shaft carries a mallet 34 for percussion in such a way that the mallet 34 assumes a desired angle with respect to the pedal body 30. A retainer of the mallet 34 is coupled to an end of the pedal body 30 by a flexible member 35 so that the depression of the pedal body 10 drives the rotation of the mallet 34 for percussion. To provide automatic returning of the pedal and the mallet 34 after percussion in order to allow for successive percussion operation, a positioning member 36 is mounted to an outer end of the shaft 33 in proximity of one of the posts 32 and is connected to the base 31 by a spring 37 so that after the rotation of the positioning member 36 with the shaft 33, the spring 37 generates a returning force for the positioning member 36, which simultaneously brings the pedal 30 and the mallet 34 back the original positions before percussion. Although in such a resilient returning mechanism, the assistance provided by the spring force can effectively realize the desired returning operation, yet the reciprocal motion of the spring 37 can vary with the treading force acting on the pedal, leading to imprecise returning due to inconsistence of the spring force. Further, the reciprocal motion of the spring 37 may cause noise due to the impact between metal parts and such a noise interferes with the music performance, especially when a microphone is placed in proximity of the drum in a regular stage layout, which leads to significant trouble of sound interference. The noise caused by the spring 37 is often of high frequency and is thus more noticeable in slow or bass rhythm. Such a problem is apparently not alleviated by the currently existing designs of pedal. Thus, it is desired to improve such a situation that undesired sound effect may be caused by the pedal 30 at the time when no percussion occurs.

### SUMMARY OF THE INVENTION

The primary purpose of the present invention is to provide an improvement of the drum pedal assembly that is operated with expelling forces induced between magnetic poles of magnets that are respectively mounted to an erected plate support and a rotary member opposing the plate support to have identical poles opposing each other so as to ensure assistance of returning provided by magnetic expelling force at the time when approaching is effected by rotation motion and to eliminate noise caused by impact between metal parts in the returning course, and the structure and assembling are simplified and of practicability and totally overcome the noise problem occurring in the currently existing drum pedals.

An objective of the present invention is to provide a drum pedal wherein a rotary member is mounted to a rotary shaft and magnet pads are mounted to the rotary member and an opposing erected plate support. With the assistance realized by the magnetic expelling force, automatic returning of the mallet and pedal can be effected after percussion. Further, due to the assistance provided by the magnetic force, no incorrect action or noise during the returning process may occur, leading to excellent result of percussion performance and an economic value of easy assembling of the whole construction.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a drum pedal constructed in accordance with the present invention;

FIG. 2 is a side elevational view of the drum pedal of the present invention before percussion;

FIG. 3 is a side elevational view of the drum pedal of the present invention after percussion;

FIG. 4 is a side elevational view of the drum pedal of the present invention illustrating a different arrangement of magnet pads;

FIG. 5 is a perspective view illustrating a conventional drum pedal assembly.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

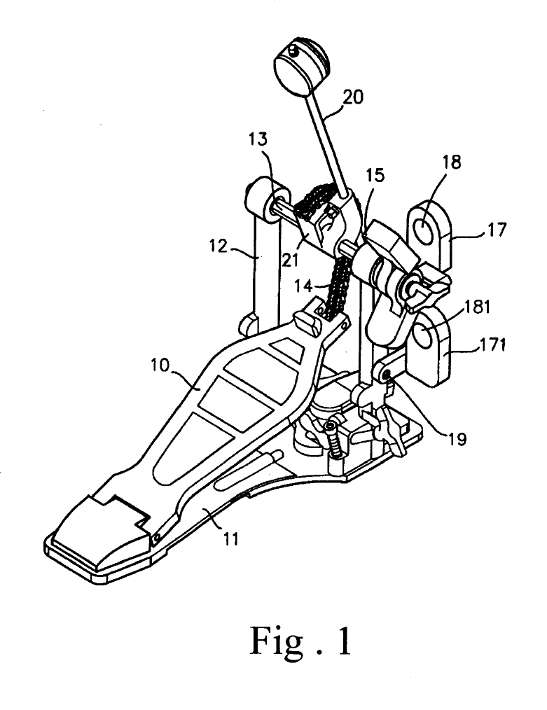

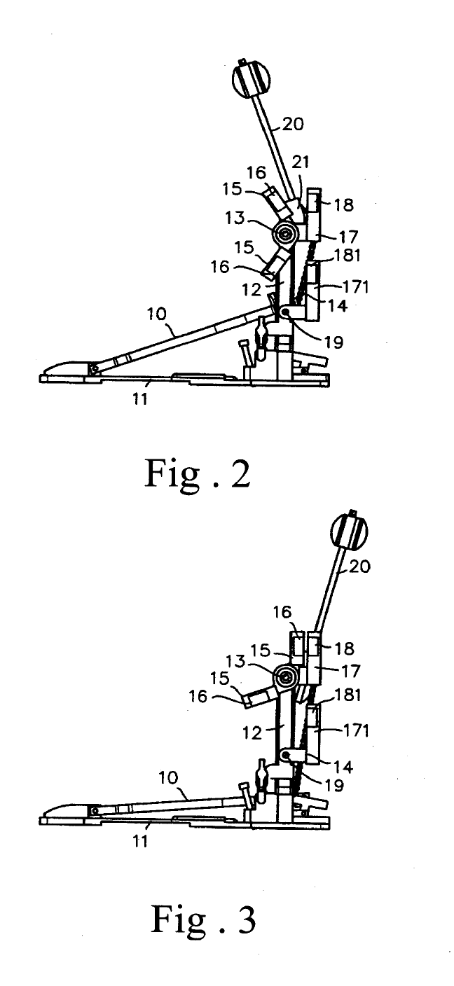

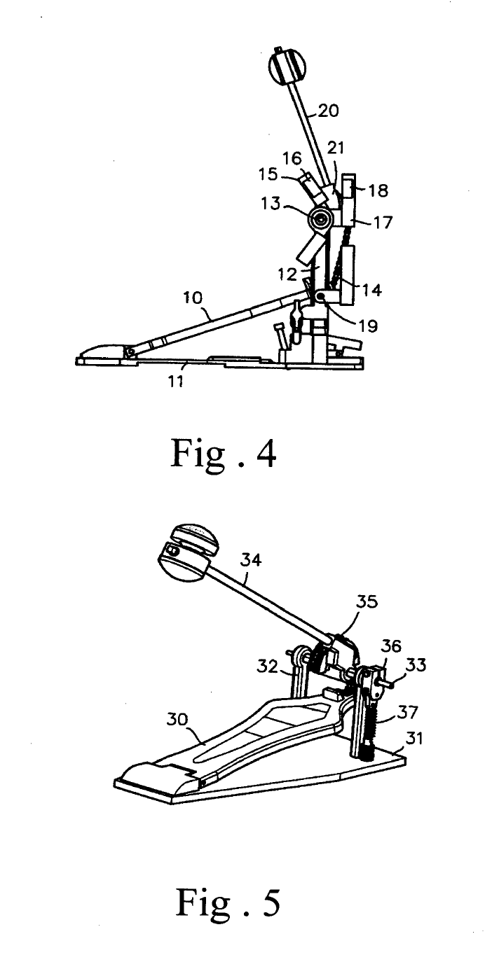

With reference to the drawings and in particular to FIGS. 1-4, the present invention provides an improved structure of drum pedal assembly for percussion. The drum pedal of the present invention comprises a pedal body 10, which is of a polygonal configuration resembling the shape of a sole for being trod and depressed by a sole. An underside of the pedal body 10 is pivoted to a base 11 to allow the pedal body 10 to make up and down reciprocal rotational motion. On an end of a top surface of the base 11 that is close to a moving end of the pedal body 10, two spaced posts 12 are arranged on opposite sides of the base 11 for mounting a rotary shaft 13. An intermediate section of the shaft 13 that is exactly corresponding to and above the pedal body 10 carries a mallet retainer 21 that functions to mount a mallet 20. The mallet retainer 21 is connected, at one side thereof, by a flexible member 14 to the moving end of the pedal body 10 so that the mallet 20 can be driven by the depression of the pedal body 10 to move, realizing the operation control of rotation for percussion of drum. On the shaft 13 outside one of the posts 12, a set of rotary members 15, which are arranged at inclination angles that are close to the inclination of the arrangement of the mallet 20, are mounted and located on upper and lower sides thereof. A front face of each rotary member 15 is provided with a magnet pad 16. At a further side location in front of the rotary members 15 by a suitable distance, upper and lower plate supports 17, 171 are respectively mounted to the base 11 and the post 12. Alternatively, the two plate supports 17, 171 can be combined as a unitary, erected plate that can be mounted to the base 11 or can be formed as a rearward extending integral projection from the post 12. On the plate supports 17, 171, magnet pads 18, 181 are mounted at locations substantially opposing the magnet pads 16 of the rotary members 15 so that in the percussion of the drum when the pedal body 10 is depressed or downward trod, with the shaft 13 being driven by the flexible member 14 to rotate in a given direction, the mallet 20 is rotated forward to realize the operation of percussion of the drum to give off sounds. The rotary member 15 on one side of the shaft 13 is also rotated in unison therewith in the forward direction. When shaft 13 is rotated to the percussion position of the mallet 20, since the magnet pads 16, 18 that are respectively mounted to opposing surfaces of the rotary member 15 and the plate support 17 are arranged to have opposite polarities, a repulsive separation force is induced, so that when the depression or treading force acting on the pedal body 10 is released or removed, due to the action of the magnetic expelling force, the rotary member 15 is forced away the proximate, approaching position, causing the shaft 13 to rotate in a backward direction. This, together with assistance provided by the backward swinging of the mallet 20 due to the gravitational force thereof and the coupling with the flexible member 14, efficiently and effectively move the mallet 20 and the pedal body 10 back to the original positions before the percussion. By further assistance for positioning by the magnetic force induced between the magnet pad 16 of the lower-side rotary member 15 and the magnet pad 18 of the lower plate support 171, the operation control of returning of the mallet 20 can be efficient with assured positioning. The operation and control of the reciprocal motion of the pedal body 10 in accordance with the present invention is completely realized with magnetic expelling/attractive force(s) and does not need any physical contact or engagement between parts and thus, no noise will be generated either before or after percussion of drum to ensure perfect performance of drums or excellent sound effect of music performance.

In accordance with the present invention, the operation of the mallet 20 is assisted by magnetic expelling/attractive force(s), and the reciprocal motion of the pedal body 10 can be of a safe and soundless returning without any delay in return caused by mechanical coupling or noise caused by impact of parts, thereby realizing the practical effectiveness of efficiency and assuredness of returning operation. The whole structure is simple and can be of any desired modification of assembling by changing the assembling length of the mallet 20 and the actual magnitude of the magnetic forces induced by the magnets. It is also convenient to selectively mount, at opposite angular positions on the upper and lower sides of the shaft 13, a single location or different locations of the upper and lower sides, a magnetic force based returning mechanism. Such a magnetic force based returning mechanism can be made separately and easily mounted with bolts 19. The present invention also allows easy replacement/assembling on the currently existing pedal body 10 to realize soundless effect and is thus most suitable for high class music performances. The present invention provides a practical structure of high-quality, soundless pedal assembly, which is novel and of rich practical values.

To conclude, the drum pedal assembly in accordance with the present invention uses the magnetic interaction between magnet pads to realize control of returning of mallet, so that simply with the magnetic force acting on the shaft, the returning rotation of the shaft can be simply controlled after the pedal is trod, providing a soundless design.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A drum pedal assembly comprising a pedal and a base to which the pedal is pivoted, posts arranged on opposite sides of the base at a location corresponding to a free end of the pedal, a shaft rotatably mounted to the posts, and a mallet mounted to the shaft for rotation and percussion of a drum, wherein the shaft mounted on the posts of the base has an extension to which at least one rotary member is mounted and a plate support is arranged outside each rotary member and is spaced from and opposing each rotary member, magnets being mounted to opposing surfaces of the rotary member and the plate support in such a manner that identical polarity of the magnets oppose each other, so that after percussion by treading the pedal, an expelling force is induced to realize automatic separation and thus returning of the pedal is ensured in a soundless manner.

2. The drum pedal assembly as claimed in claim 1, wherein the rotary member is mounted to the shaft on an upper side of the shaft and is inclined at an angle that is close to inclination of the mallet.

3. The drum pedal assembly as claimed in claim 1, wherein two rotary members are mounted the shaft respectively on upper and lower sides of the shaft at opposite angular positions.

4. The drum pedal assembly as claimed in claim 1, wherein the plate support is mounted to the base or the post by a threaded fastener.

5. The drum pedal assembly as claimed in claim 1, wherein the plate support is directly mounted to the post.

6. The drum pedal assembly as claimed in claim 1, wherein two plate supports are provided and respectively corresponding to two rotary members and wherein the two plate supports are combined together and mounted to the post or the base.
